(19) United States
(12) Patent Application Publication
(10) Pub. No.: US 2004/0016082 A1
(43) Pub. Date: Jan. 29, 2004

(54) Power tool with at least one handle

(76) Inventor: Zhiyong Yi, Suzhou (CN)

Correspondence Address: James V. Costigan, Esq., Hedman & Costigan, P.C., Suite 2003, 1185 Avenue of the Americas, New York, NY, 10036-2646, US

(21) Appl. No.: 10/424,565

(22) Filed: Apr. 28, 2003

(30) Foreign Application Priority Data
Apr. 30, 2002 (CN) 02220382.6

(51) Int. Cl. B25F 5/02

(52) U.S. Cl. 16/421; 16/431

(57) ABSTRACT

A power tool with at least one handle, comprises at least one handle [1], a power tool body [12], said handle [1] includes at least a gripping member [2], at least one elastic vibration absorbing members are disposed with said gripping member [2]. Said elastic members [3,4] are attached in an inside bore [13] of said gripping member [2], a rigid connecting member [5] go through said elastic members [3,4] and connected with them. Said rigid connecting member [5] also connect to attachment member [7], said attachment member [7] connect to elastic members [4,6]. Said rigid connecting member can increase the strength of said elastic anti-vibration members and also can protect them from wearing off, said rigid connecting member and said attachment member all connected by said elastic anti-vibration members to said gripping member, so the vibration-absorbing effect is perfect.

### TECHNICAL FIELD

The present invention relates to power tools with at least one handle.

### BACKGROUND INFORMATION

The patent CN1319477 disclosed a power tool with at least one handle, the handle portion is attached to the housing of the power tool body by a attachment member and at least one elastic vibration-damping members, said handle portion connect to said attachment member by a movable insuring member. Said vibration-damping members are disposed at one end of said handle portion, so once said vibration-damping members wearing, said handle portion still connect with the portable power tool by said insuring member. Moreover, even said insuring member can be made in fashion of a movable element, while this kind of connection of said insuring member still can transmit vibration-in-part to operator. Meanwhile, said vibration-damping member will be worn out quickly result in that it is disposed at one end of the handle portion.

### SUMMARY OF INVENTION

The object of the present invention is to provide a power tool with a handle, which can supply a good anti-vibration effect and can not be wear off easily.

The technology proposal of the present invention: a power tool with at least one handle, including a handle and power tool body, said handle at least including a gripping member, at least one elastic vibration absorbing members are disposed with said gripping member. Said elastic members are attached in an inside bore of said gripping member, the outer surface of said elastic anti-vibration member adjacent with the inner surface of said bore of said gripping member, a rigid connecting member go through said elastic members and connected with the later, said rigid member connect to said gripping member in a non-contact fashion, said rigid connecting member also connect to an attachment member, which is connected to elastic members. Said attachment member and said rigid connecting member connect to the machine body of a power tool.

Compared with the prior art, the present invention has the following advantages: Said rigid member can increase the strength of the elastic anti-vibration member, said elastic anti-vibration members are disposed in said bore of the gripping member of the handle of a power tool, so said elastic anti-vibration members are not wore out so quickly, besides, said rigid member and said attachment member all connect to said gripping member by said elastic anti-vibration members, so a perfect vibration-damping effect is obtained.

### BRIEF DESCRIPTION OF THE DRAWINGS

FIG. 1 shows a projective view of the present invention.

FIG. 2 shows a sectional view of the handle of the present invention, aim at showing the main structure of said handle.

FIG. 3 shows an exploded view of said handle. Wherein: [1] a handle; [2] a gripping member; [3] a first elastic anti-vibration member, [4] a second elastic anti-vibration member; [5] a rigid member; [6] a outer connecting member; [7] an attachment member; [8] a neck portion of said inside bore of said gripping member; [9]one enlarged end portion of said rigid member; [10] a flange portion of the gripping member; [11] a housing portion of a power tool; [12] a body of a power tool; [13] a inside bore of said gripping member;

### DESCRIPTION OF THE PREFERED EMBODIMENTS

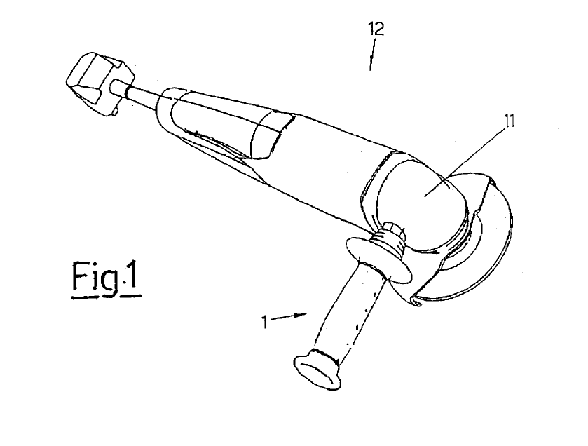

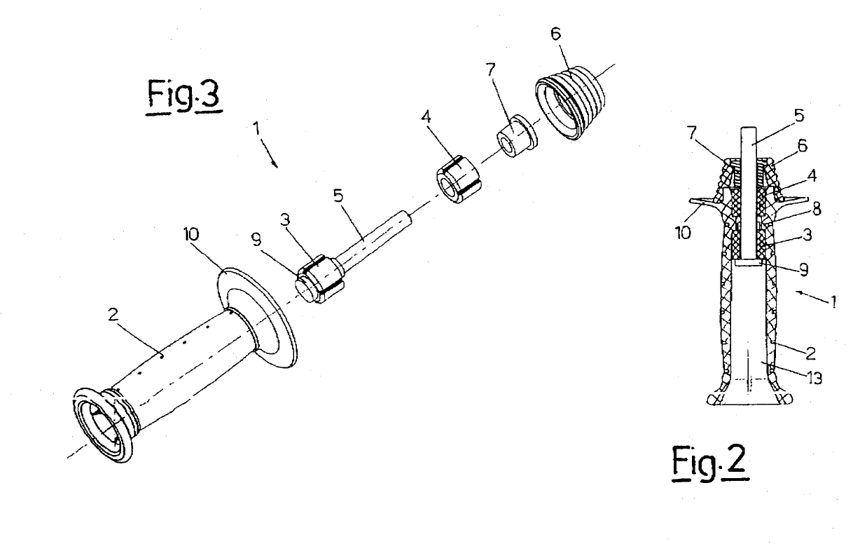

See FIG. 1, A power tool with at least one handle, comprising at least one handle [1], and a power tool body [12]. See FIG. 2 and FIG. 3, said handle [1] at least including a gripping member [2], at least one elastic vibration absorbing members [3,4,6] are disposed with said gripping member [2], said elastic members [3,4] are attached in an inside bore [13] of said gripping member[2], the outer surface of said elastic anti-vibration members [3,4] adjacent with the inner surface of said bore [13] of said gripping member[2], a rigid connecting member [5] go through said elastic members [3,4] and connected therein. Said rigid connecting member [5] is connected to said gripping member[2] in a non-contact fashion, so the vibration of said rigid connecting member [5] can not be transmitted directly to said gripping member[5].

Said rigid connecting member [5] also connect to said attachment member [7], which is connected to elastic members [4,6]. Said attachment member [7] and said rigid connecting member [5] connect to said housing portion of said body of said power tool.

The portion of aid rigid connecting member [5] which protrude beyond said attachment merger [7] being a support stud portion, which connect with said housing portion [11] of said power tool, alternately, also can work by said screwed attachment member [7] connect with said housing portion [11], so both said rigid connecting member [5] and said attachment member [7] are being a attachment member.

Said elastic members in said inside bore [13] of said gripping member [2] include a first elastic anti-vibration member [3] and a second elastic anti-vibration member [4], they respectively are disposed at each side of said neck portion of said inside bore of said gripping member which radius becoming smaller, said rigid connecting member [5] go through center openings of said first elastic anti-vibration member and said second elastic anti-vibration member in turn and mounted wherein.

The portion of said rigid connecting member [5] which lies in the inside bore [13] is being said enlarged end portion of said rigid member [9], the diameter of said enlarged end portion of said rigid member [9] is smaller than the diameter of said neck portion of said inside bore [13] of said gripping member [8]. Once said first elastic anti-vibration member and said second elastic anti-vibration member wearing out, said enlarged end portion of said rigid member [9] can escape out of said inside bore of said gripping member [8], whereby said gripping member [2] separate from said rigid connecting member [5].

The end portion of said attachment member [7] is connected to said second elastic anti-vibration member [4]. At the same time, said attachment member [7] also connect to said outer connecting member [6], said outer connecting member [6] connect with said gripping member [2], whereby said attachment member [7] connect to said gripping member [2] via said elastic anti-vibration members [3,4].

1. A power tool with at least one handle, comprising at least one handle [1], a power tool body [12], said handle [1] including at least a gripping member [2], at least one elastic vibration absorbing members are disposed with [3,4,6] said gripping member [2], characterized in that said elastic members [3,4] are disposed in an inside bore [13] of said gripping member [2], the outer surface of said elastic anti-vibration members [3,4] adjacent with the inner surface of said inside bore [13] of said gripping member [2], a rigid connecting member [5] go through said elastic members [3,4] and connected therein, said rigid member connect to said gripping member [2] in a non-contact fashion, said rigid connecting member [5] also connect to attachment member [7], said attachment member [7]connect to elastic members [4,6], Said attachment member [7] or said rigid connecting member [5] connect at said housing portion of the machine body of a power tool.

2. The power tool of claim 1, wherein a portion of said rigid connecting member [5] which protrudes beyond said attachment member [7] is provided with provided with screw thread and is treadedly connect at said housing portion of said power tool.

3. The power tool of claim 1, wherein Said elastic members in said inside bore [13] of said gripping member [2] include a first elastic anti-vibration member [3] and a second elastic anti-vibration member [4], they respectively are disposed at each side of said neck portion of said inside bore of said gripping member, wherein inside diameter of said neck portion becomes smaller, said rigid connecting member [5] goes through both said first elastic anti-vibration member and said second elastic anti-vibration member.

4. The power tool of claim 1, wherein an end of said rigid connecting member [5] which in disposed in said inside bore [13] is a radial projected end [9] of which radius is enlarged, a diameter of the projected end [9] is smaller than the diameter of said neck portion of said inside bore [13] of said gripping member [8].

5. The power tool of claim 3, wherein the end portion of said attachment member [7] connect to said second elastic anti-vibration member [4], said attachment member [7] also connect to said outer connecting member [6], said outer connecting member [6] connect to said gripping member [2].
